(19) United States
(12) Patent Application Publication
(10) Pub. No.: US 2008/0007394 A1
(43) Pub. Date: Jan. 10, 2008

(54) INTEGRATED SENSOR AND LIGHT LEVEL ADJUSTMENT APPARATUS FOR "DAYLIGHT HARVESTING"

(76) Inventor: L. Michael ROBERTS, Goderich (CA)

Correspondence Address: BORDEN LADNER GERVAIS LLP;Anne Kinsman, WORLD EXCHANGE PLAZA, 100 QUEEN STREET SUITE 1100, OTTAWA, ON, K1P 1J9, CA

(21) Appl. No.: 11/771,142

(22) Filed: Jun. 29, 2007

Related U.S. Application Data
(60) Provisional application No. 60/806,321, filed on Jun. 30, 2006.

(51) Int. Cl. B60Q 1/26

(52) U.S. Cl. 340/469

(57) ABSTRACT

The invention is directed at a method and system for controlling lighting in an enclosed space. A daylight harvesting apparatus for controlling an amount of light in an associated work area comprises a sensor assembly for sensing an amount of illumination in a proximity of the apparatus; a controller for receiving a value representing the amount of illumination and for determining an lamp control signal to be provided based on the amount of illumination; and an artificial light source for providing light, corresponding to the lamp control signal, to the work area.

### CROSS REFERENCE TO RELATED APPLICATIONS

This application claims the benefit of priority of U.S. Provisional Patent Application No. 60/806,321 filed Jun. 30, 2006, which is incorporated herein by reference.

### FIELD OF THE INVENTION

The present invention relates generally to daylight harvesting. More particularly, the present invention relates to an integrated sensor and light level adjustment apparatus for daylight harvesting.

### BACKGROUND OF THE INVENTION

Daylight harvesting is a method of reducing electrical energy consumption by taking advantage of the natural light entering an enclosed space through windows, skylights or other transparent openings.

In many office buildings, large windows, skylights and other transparent openings surround an enclosed space and allow for daylight, or natural light, to enter the enclosed space. Most of these enclosed spaces are also illuminated by artificial lighting such as overhead light fixtures. Most buildings have “bank” switching where large blocks/banks of light fixtures are turned on and off from a single switch or control panel which leads to a situation where lights are on in areas where they are unnecessary thus increasing electrical energy consumption.

In other circumstances, light entering through the transparent openings are insufficient for certain tasks. In most buildings, the artificial lighting is turned on at full brightness to supplement the natural light even though only a certain percentage of the artificial lighting is needed to supplement the natural light in order to maintain sufficient lighting for performing certain tasks.

Recent advances in technology have included the use of light sensors to determine the level of light in an enclosed space and then either switching on a minimal number of artificial light sources to produce an adequate light level, or dimming the lights such that a minimum amount of power, or energy, necessary for adequate lighting is used. Most of these systems are complex and inflexible and usually consist of a central photo sensor or one photo sensor per occupied area/office, which then controls all of the lighting in that office/area. Often the sensors must be wired to a central location where the light levels are controlled, although some wireless systems have become available.

Therefore, there is provided an integrated sensor and light level adjustment apparatus for daylight harvesting.

### SUMMARY OF THE INVENTION

It is an object of the present invention to obviate or mitigate at least one disadvantage of previous light control systems.

The invention is directed at individual light control apparatus for individual work areas so that a desired task lighting level below each apparatus is maintained on a per/fixture basis for finer control and greater energy savings.

In a first aspect, the present invention provides a daylight harvesting apparatus for controlling an amount of light in an associated work area comprising a sensor assembly for sensing an amount of illumination in a proximity of the apparatus; a controller for receiving a value representing the amount of illumination and for determining an lamp control signal to be provided based on the amount of illumination; and an artificial light source for providing light, corresponding to the lamp control signal, to the work area.

In a further embodiment, there is provided a system for controlling light provided to an enclosed space comprising a plurality of daylight harvesting apparatuses, located at predetermined locations throughout the enclosed space, each daylight harvesting apparatus including a sensor assembly for sensing an amount of illumination in a proximity of the apparatus; a controller for receiving a value representing the amount of illumination and for determining an lamp control signal to be provided based on the amount of illumination; and an artificial light source for providing light, corresponding to the lamp control signal, to the work area.

In further aspect, the present invention provides a method for controlling an amount of light in an associated work area comprising sensing an amount of illumination in the work area; transmitting a value representing the amount of illumination to a controller; calculating a light control signal based on the value representing the amount of illumination using a dimming curve generator; transmitting the provided light value to a ballast; and powering an artificial light source based on the provided light value.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a schematic diagram showing a plurality of daylight harvesting apparatuses in an enclosed space;

FIG. 2 is a perspective view of a daylight harvesting apparatus;

FIG. 3 is a perspective view of a sensor assembly of the daylight harvesting apparatus;

FIG. 4 is a cut away view of the sensor assembly of FIG. 3;

FIG. 4a is an exploded view of the sensor assembly;

FIG. 5 is a schematic diagram of a controller of the daylight harvesting apparatus;

FIG. 6 is a chart outlining light output and total level versus time; and

FIG. 7 is a flowchart outlining a method of controlling light being provided to a work area.

### DETAILED DESCRIPTION

Generally, the present invention provides a method and system for controlling lighting in an enclosed space. Individual apparatus are provided for individual light fixtures within an enclosed space to provide for individual control for each work area.

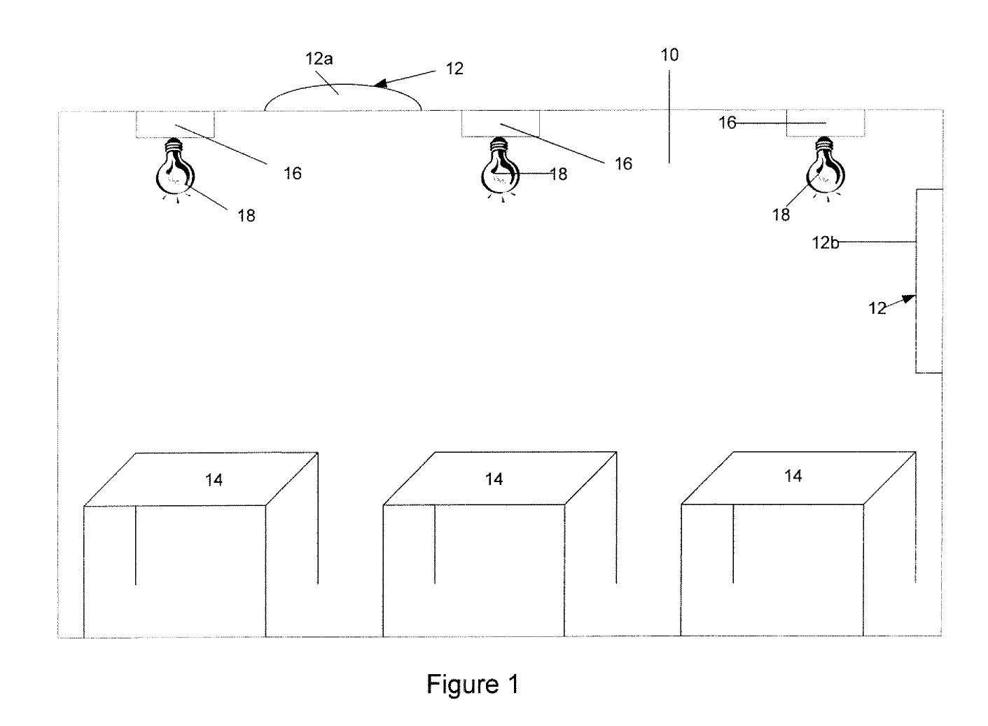

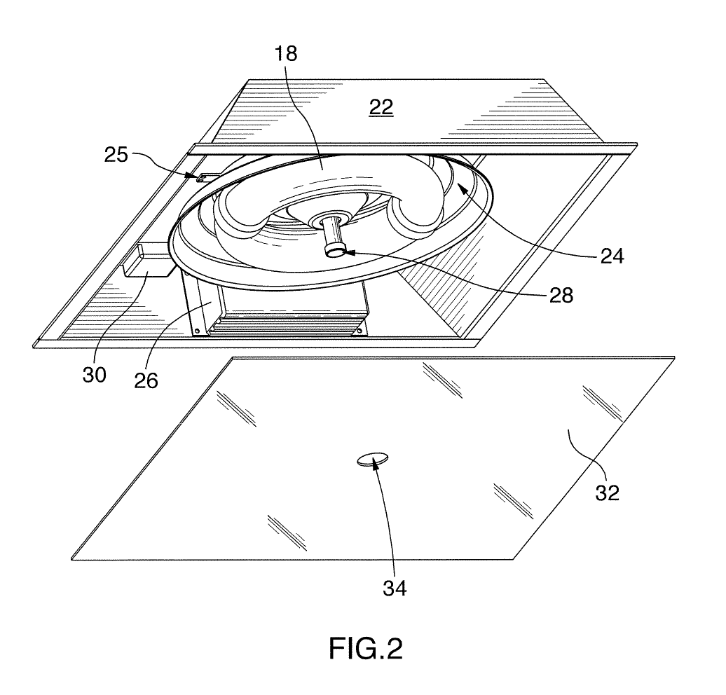

Turning to FIG. 1, a schematic diagram of an enclosed space 10 is shown. The enclosed space 10 includes a plurality of transparent openings 12, such as a sunroof 12a and a window 12b. As will be understood, the enclosed space can include any number of transparent openings 12. The transparent openings 12 allow for natural light, such as sunlight, to enter and illuminate the enclosed space 10. Within the enclosed space 10 are individual work areas 14 represented by the three desks. Over each of the work areas 14 is a daylight harvesting apparatus 16 which includes an artificial light source 18, seen as a light bulb. The artificial light source 18 can also be a fluorescent light source. A more detailed view of an embodiment of the daylight harvesting apparatus 16 is provided in FIG. 2.

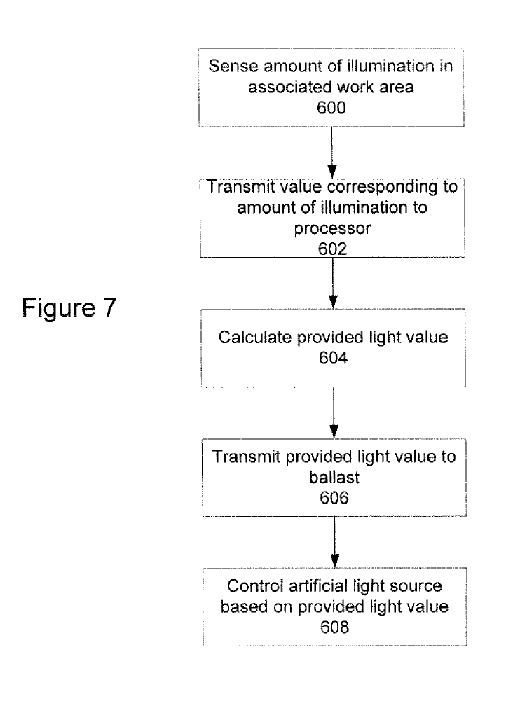

Each of the daylight harvesting apparatus 16 controls the amount of light provided by its associated artificial light source 18 to the associated work area 14 based on the amount of light, both natural and artificial, that it senses in its proximity, or vicinity. The apparatus then controls the illumination provided by the artificial light source 18 based on the amount of light sensed. This process will be described in more detail below with respect to FIG. 7.

Turning to FIG. 2, a more detailed schematic of a first embodiment of the daylight harvesting apparatus 16 is shown. The apparatus 16 includes a light fixture 22 which houses the artificial light source 18, such as a round light emitting tube or an incandescent light bulb. In the current embodiment, the daylight harvesting apparatus 16 is a “ceiling trough” type lighting fixture which can be mounted in a drop ceiling or any other ceiling where a cavity exists within the ceiling to accommodate the apparatus. However, other types of light fixtures are also contemplated.

The apparatus 16 further includes a reflector 24, mounted to the light fixture 22 via a mounting apparatus 25, above the artificial light source 18, which directs the light emitted by the artificial light source 18 towards the work area 14. A ballast 26 is used to interface the light source 18 with an electrical voltage for providing the necessary power to illuminate the light source 18. As will be understood, the electrical voltage is provided by a set of wires (not shown) from a power source, located remote from the apparatus 16.

The apparatus 16 further comprises a sensor assembly 28 to detect the amount of illumination in the proximity, or vicinity, of the apparatus 16 and a controller 30 to control the amount of light being supplied by the artificial light source 18 in response to the amount of sensed illumination. A diffuser 32 is located at a bottom of the fixture 22 to reduce or eliminate the opportunity for alien matter, such as airborne dust, to enter the apparatus 16. The diffuser 32 also spreads, or diffuses, the light being provided by the artificial light source 18. The diffuser 32 includes a central hole 34 through which the sensor assembly 28 can protrude in order to obtain an unobstructed reading of the illumination in its associated work area 14. As will be understood, other sensor assembly arrangements are possible without affecting the scope of the invention. For instance, the sensor assembly 28 can be mounted to the outside of the light fixture 22.

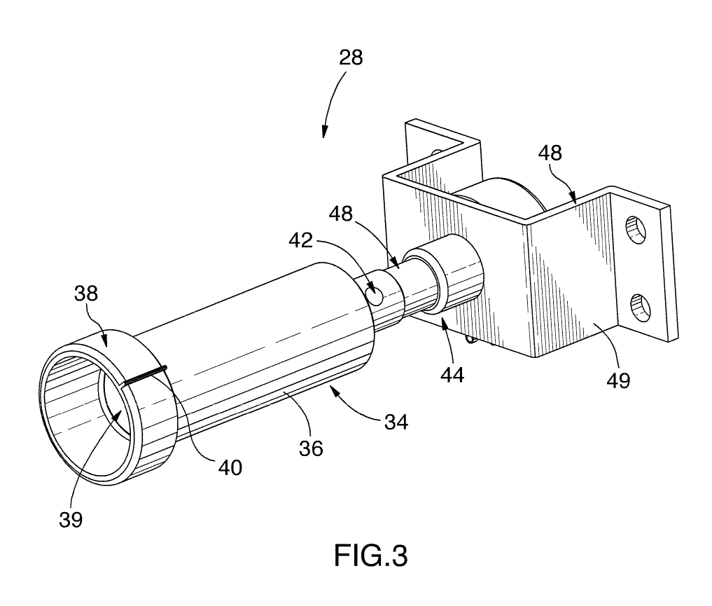

Turning to FIG. 3, a perspective view of an embodiment of the sensor assembly 28 is shown. The sensor assembly 28 comprises a main body 34, having a body portion 36 and an aperture portion 38, both preferably manufactured from a dark coloured moulded plastic or metal so that stray light reflections are reduced, or eliminated, after entering the sensor assembly 28. The aperture portion 38 has sloping sides so that any light entering the aperture portion 38 is directed towards the body portion 36. Within the aperture portion 38 is a light input aperture 39. An indicator line 40 is mounted, etched, engraved or painted onto the surface of the aperture portion 38 and is used to relate light readings to a scale on the exterior of the light fixture 22 to display the various light levels that are output by the artificial light source 18. Use of the scale and indicator line 40 allows the apparatus to be adjusted such that a certain amount of light, for example 300 lumens, is available at the work surface 14. The indicator line 40 can be adjusted by rotating the body portion 36 about a shaft 46 of a potentiometer 44, which is attached via a fastening means 42, such as an attachment screw. The potentiometer 44 also includes a potentiometer body 48.

The sensor assembly 28 further comprises an assembly mounting bracket 49 for mounting the sensor assembly 28 to the light fixture 22.

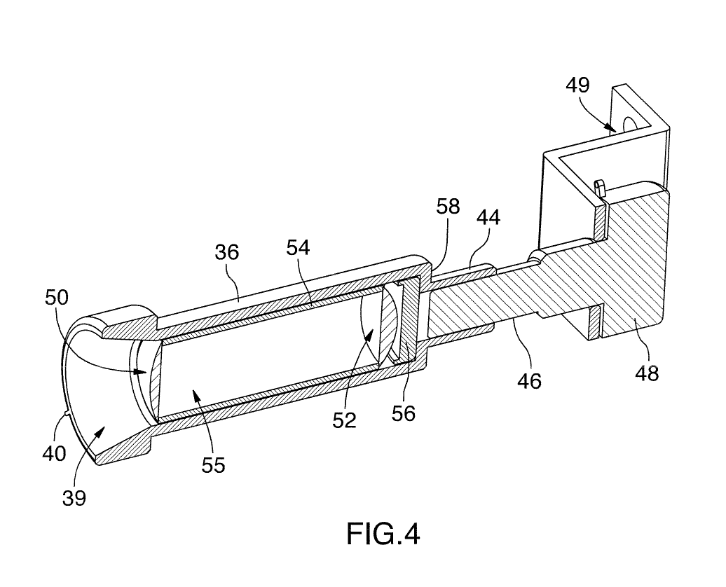

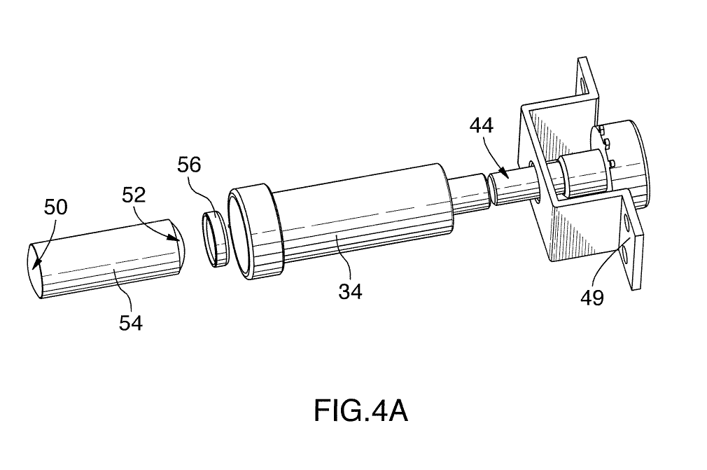

Turning to FIG. 4, a cross-section of the sensor assembly 28 of FIG. 3 is shown. FIG. 4a provides an exploded view of the sensor assembly 28. Light is collected from the area below the sensor assembly 28 and enters the main body 34 via the light input aperture 39 in the aperture portion 38. This light is then collected in the aperture portion 38 and focused, by the sloped edges, on a front lens 50 of an optical telescope 55. The optical telescope 55 also includes a rear lens 52 and a optics mounting tube 54 with the front and rear lenses located at opposite ends of the mounting tube 54. The required distance for optimal focus is determined by the distance between the front 50 and rear 52 lenses and maintained by the optics mounting tube 54.

A photo detector 56 is located adjacent the rear lens 52 along with a wire exit hole 58.

By changing the focal length of the front lens 50 and rear lens 52 by changing the length of the optics mounting tube 54, the area being sensed by the sensor assembly 28 can be varied to accommodate various light fixture mounting heights. In one embodiment, the area being sensed can be 1.5 meters in diameter at a distance of 3 meters from the aperture portion 38 but other combinations are possible without departing from the scope of this invention.

The illumination being sensed, which is a combination of natural light from the transparent openings 12 and artificial light from the artificial light source 18, is focused by the telescope 55 onto the photo detector 56. In one embodiment, a front face of the photo detector 56 can be covered with a glass or plastic diffuser, or a diffusing coating, to average the light falling onto the face of the photo detector 56 in order to improve the accuracy for the sensed illumination readings. After receiving the focused light from the optical telescope 55, the photo detector 56 generates a variable electronic output signal in proportion to the amount of illumination that is sensed. The photo detector 56 closely matches the mesopic sensitivity curve of the human eye such that changes of the light levels in parts of the spectrum outside the sensitivity of the human eye are ignored and only changes in light levels within the spectral response of the human eye are measured by the photo detector 56. This is accomplished by using a photo detector 56 which either has a spectral sensitivity with the desired curve, or can be accomplished by covering the face of the photo detector 56 with a glass or plastic filter which has the appropriate band pass characteristics. A set of electrical wires connect the photo detector 56 to the controller 30 of the sensor assembly 28 by means of the exit wire hole 58 where they can be grouped into a bundle with wires connected to the potentiometer 44.

The potentiometer 44 serves as a support for the sensor assembly 28 but also allows the sensor assembly 28 to rotate about the central axis of the main body 34, thereby changing the resistance of the potentiometer 44 and setting a desired light level to be maintained below the fixture. In this manner, the amount of light being provided to the work area can be predetermined such that the level of artificial light is constantly being updated as a response to the amount of natural light being provided to the work area 14.

The photo detector 56 and the potentiometer 44 are connected to the controller 30 which contains the electronics necessary for detecting the existing light levels, determining the pre-set light levels required by reading the value of the potentiometer 44, and then outputting a control signal to the ballast 26.

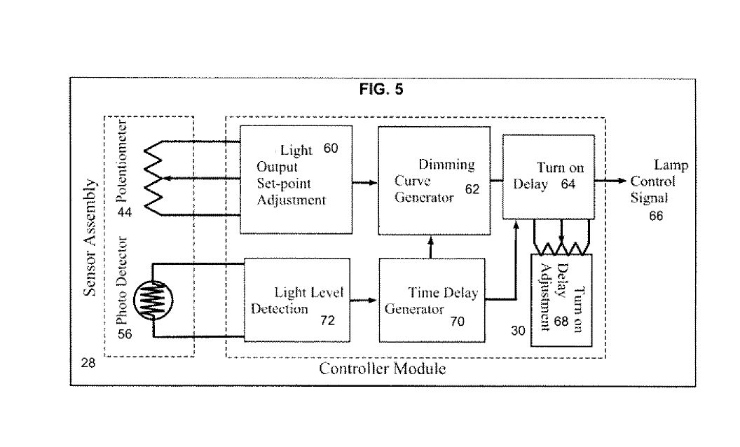

Turning to FIG. 5, a schematic diagram of an embodiment of the controller 30 is shown. The controller 30 includes a light output set-point adjustment 60 which is connected to the potentiometer 44 and a dimming curve generator 62. The generator 62 is connected to a turn on delay 64. The turn on delay 64 produces a lamp control signal 66. The turn on delay 64 is also connected to a turn on delay adjustment 68 and a time delay generator 70. The time delay generator 70 is connected to the dimming curve generator 62 and to a light level detection circuit 72 which, in turn, is connected to the photo detector 56.

The electrical signal, generated by the photo detector 56, is processed by the light level detection circuit 72 and passed to the time delay generator 70. The time delay generator 70 controls the output of the artificial light source 18 for a predetermined period of time, such as between 10 to 60 seconds. The time delay generator 70 provides assistance, or protection, to the apparatus 16 from reacting to sudden and brief changes in exterior light levels such as from lightening strikes, aircraft shadows or flashes of light reflected from vehicles. Other light changing scenarios are also possible.

The potentiometer 44 is adjustable by the user to a suitable set point such that the combination of natural light and artificial light provides a suitable, or predetermined, light level to the work area 14. Suitable light levels can be predefined by a user and then selected by the user so that the system recognizes the amount of light required to be supplied to the work area 14.

On brighter days, when the natural light being supplied through the transparent openings 12 is high, the sensor assembly 28 detects this and the controller 30 transmits the lamp control signal 66 to the ballast 26 to dim the artificial light source 18 to reduce the amount of energy required to supplement the natural light in the work area 14. In this manner, on darker days, the lamp control signal is used to increase the light being provided by the artificial light source 18.

Outputs from the light level set-point adjustment 60 and the time delay generator 70 are both transmitted to the dimming curve generator 62 which functions to integrate the signals and issue the lamp control signal 66 to the ballast 26 via the turn on delay circuit 64 of the controller 30.

The turn on delay 64 of the controller suppresses the lamp control signal 66 to the ballast 26 so that the artificial light source 18 is able to fully power up. In some scenarios, the artificial light source 18 is required to provide 100% output for an amount of time determined by the turn on delay adjustment 68 that is internal to the controller 30 and is not user adjustable. The function of the turn on delay circuit 64 is to delay the generation and application of the lamp control signal 66 until such time as the artificial light source 18 has had time to warm up and stabilize at a maximum output before dimming control is implemented. In the case of fluorescent lamps for example, this delay might be very short—in the order of 15 to 20 seconds—whereas for some types of metal vapour lamps, the delay might be 5 minutes or more.

Once the turn on delay 64 has expired, the apparatus 16 enters normal operation and light levels are sensed by the photo detector 56 and sent via the time delay generator 72 to the dimming curve generator 62 of the controller 30. The dimming curve generator 30 is responsible for gradually dimming or brightening the artificial light source 18 in response to the changing illumination levels being sensed. The control of the dimming or brightening of the artificial lighting is accomplished by means of the lamp control signal 66, which is sent to the ballast 26 in the light fixture 22.

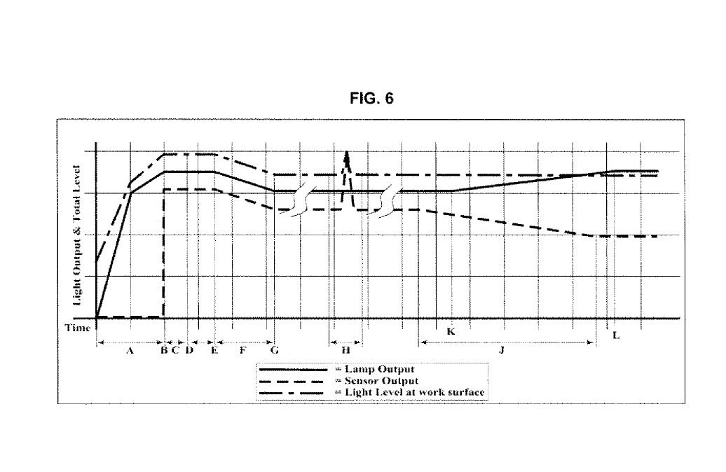

Turning to FIG. 6, a graph showing various phases of the operation of the apparatus is shown. During the section marked A on the graph, the system is first turned on and the turn on delay section 62 of the controller 30 inhibits the lamp control signal 66 from reaching the ballast 26 to change the output of the artificial light source 18 below 100%. The delay is provided, with the length of the delay adjusted, by the turn on delay adjustment 64, in order to allow the artificial light source 18 time to warm up to full output.

The section of the graph marked C represents a period where the apparatus is first activated after a turn-on delay generated by the turn-on delay portion 62 of the controller 30. During this time, the sensor assembly 28 measures the light, or illumination, level below the fixture 22 and prepares to adjust the lamp control signal 66 to start regulating the light output.

Section F of the graph illustrates the onset of the controller 30 providing the lamp control signal 66 to the ballast. By the end of time period G [at line G] in FIG. 6, the system is fully operational and the light levels are being regulated such that the desired lighting level is maintained at the work area below the light fixture 22.

Section H of FIG. 6 illustrates the effects on the system of a brief burst of light from sources such a lightening strikes, reflected light from passing vehicles or even the use of a flash equipped camera in the room where the sensor equipped lights are in operation. It will be noted that while the brief burst of brighter light is registered by the sensor assembly 28, the time delay generator 72 of the controller 30, in conjunction with the dimming curve generator 62, operate together to stabilize the light levels and the lighting fixtures do not attempt to dim the lamps to compensate for the transitory increase in brightness.

Section J of FIG. 6 illustrates the action of the system to regulate light levels as the daylight conditions change—in this example, towards the end of the day as natural light levels fall. As the sensor assembly 28 detects that the overall light levels are falling [dashed line], the controller 30 adjusts the lamp control signal 66 to the ballast such that the light level at the work surface [dashed and dotted line] remains constant by increasing the output of the lamp [solid line]. This process can also work in reverse with the lamp level decreasing as the amount of natural light increases.

Section K of FIG. 6 shows that while the light levels detected by the sensor are falling, the change in the light levels from the supplementing artificial light source have a delayed onset and increase gradually so that the adjustments to the lighting fixture are generally imperceptible to the eye.

Turning to FIG. 7, a flowchart outlining a method of controlling the amount of light in a work area is shown. Prior to use, a predetermined lighting level, or set point, for the work area is determined by a user and the potentiometer 44 is set to reflect this predetermined lighting level. The potentiometer provides the necessary resistance to counter-balance the light being sensed by the sensor assembly 28.

Typically, within the enclosed space 10 is a combination of natural and artificial light. In operation, the sensor assembly 28 of the daylight harvesting apparatus 16 senses the amount of illumination, or light, in its associated work area 14 within the enclosed space 10 (step 600). This amount of illumination, or light, is a combination of both natural and artificial light in the work area of the enclosed space 10.

The light being sensed enters the aperture portion 38 and is collected within the light input aperture 39. This collected light is then directed and focused by the sloped walls of the aperture portion 38 through the optical telescope 55 including the first lens 50, the optics mounting tube 54 and the rear lens 52 on to the photo detector 56.

The light that is focused on the photo detector 56 causes the photo detector 56 to generate a variable electronic output signal corresponding to the amount of light which has been focused. This electronic output signal can be seen as a value corresponding to the amount of light sensed by the sensor assembly 28. This electronic output signal is then transmitted to the controller 30 (step 602). The controller 30 receives the output signal via the light level detection circuit 72 which then converts the output signal to a corresponding value and passes this value to the time delay generator 70.

Concurrently, while the electronic output signal is being received, the predetermined light output set point, the predetermined light level as determined by the user, is transmitted from the potentiometer 44 to the light output set point adjustment 60. A set point is a value at which the potentiometer 44 is activated. Alternatively, it can also be used as a value at which the potentiometer 44 is de-activated.

The user determined set light output set point is then transmitted, along with the value corresponding to the electronic output signal, to the dimming curve generator 62 which calculates the lamp control signal 66 (step 604). The dimming curve generator 62 integrates the control signals from the potentiometer 44 and the light level detection circuit 72 and adjusts the artificial light source 18 by means of the control signal 66 such that changes in the brightness of the artificial light source 18 are imperceptible to the human eye.

The lamp control signal 66 is then transmitted to the ballast 26 (step 606) which then controls the power being supplied to the artificial light source 18 so that the light being provided by the artificial light source corresponds with the lamp control signal (step 608). The artificial light source 18 then provides the necessary light to the work area so that the combination of natural light and artificial light equals the predetermined light level.

In an alternative embodiment, the apparatus can be controlled remotely to transmit the predetermined light level and includes a means for automating the movement of the potentiometer.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A daylight harvesting apparatus for controlling an amount of light in an associated work area comprising,
a sensor assembly for sensing an amount of illumination in a proximity of the apparatus;
a controller for receiving a value representing the amount of illumination and for determining an lamp control signal to be provided based on the amount of illumination; and
an artificial light source for providing light, corresponding to the lamp control signal, to the work area.

2. The daylight harvesting apparatus of claim 1 wherein the sensor assembly comprises:
a main body including a body portion and an aperture portion, the body portion for housing an optical telescope; and
a potentiometer, connected to the body portion.

3. The daylight harvesting apparatus of claim 2 wherein the optical telescope comprises:
a front lens;
a rear lens; and
an optics mounting tube, located between the front and rear lenses.

4. The daylight harvesting apparatus of claim 2 wherein the aperture portion comprises slanted sides for directing light towards the optical telescope.

5. The daylight harvesting apparatus of claim 3 wherein said sensor assembly further comprises a photo detector, located adjacent the rear lens in the body portion.

6. The daylight harvesting apparatus of claim 1 wherein the controller comprises:
a light output set point adjustment connected to the sensor assembly for receiving a signal from the sensor assembly;
a dimming curve generator, connected to the light output set point adjustment;
a light level detection circuit, for receiving a light level signal from the sensor assembly;
a time delay generator, connected to the light level detection circuit and the dimming curve generator;
wherein the dimming curve generator receives signals from the light level detection circuit and the light output set point adjustment and generates an lamp control signal to control the artificial light source.

7. The daylight harvesting apparatus of claim 6 further comprising:
a turn on delay signal, for delaying the lamp control signal.

8. The daylight harvesting apparatus of claim 5 further comprising a diffuser located between the photo detector and the rear lens.

9. The daylight harvesting apparatus of claim 8 wherein the diffuser is a glass diffuser or a plastic diffuser.

10. The daylight harvesting apparatus of claim 1 wherein the artificial light source is selected from a group consisting of an incandescent light bulb, a light emitting tube and a fluorescent light bulb.

11. The daylight harvesting apparatus of claim 1 further comprising:
a ballast, connected to the controller, for controlling power supplied to the artificial light source.

12. The daylight harvesting apparatus of claim 1 further comprising:
a light fixture for housing the sensor assembly, the controller and the artificial light source.

13. The daylight harvesting apparatus of claim 12 wherein the light fixture is a ceiling trough type fixture for mounting in a drop ceiling.

14. The daylight harvesting apparatus of claim 13 wherein the light fixture comprises a diffuser to diffuse light directed at the sensor assembly.

15. The daylight harvesting apparatus of claim 14 wherein the diffuser includes a hole through which the sensor assembly protrudes.

16. A system for controlling light provided to an enclosed space comprising:
a plurality of daylight harvesting apparatuses, located at predetermined locations throughout the enclosed space,
each daylight harvesting apparatus including:
a sensor assembly for sensing an amount of illumination in a proximity of the apparatus;
a controller for receiving a value representing the amount of illumination and for determining an lamp control signal to be provided based on the amount of illumination; and
an artificial light source for providing light, corresponding to the artificial light source control signal, to the work area.

17. A method for controlling an amount of light in an associated work area comprising:
sensing an amount of illumination in the work area;
transmitting a value representing the amount of illumination to a controller;
calculating a light control signal based on the value representing the amount of illumination using a dimming curve generator;
transmitting the provided light value to a ballast; and
powering an artificial light source based on the provided light value.
